(19) United States
(12) Patent Application Publication
(10) Pub. No.: US 2012/0234577 A1
(43) Pub. Date: Sep. 20, 2012

(54) HIGH FREQUENCY POWER CABLE

(76) Inventors: Hyun-Woong KIM, Seoul (KR); Chan-Yong PARK, Gunpo-si (KR); Soo-Jung YANG, Busan (KR)

(21) Appl. No.: 13/417,566

(22) Filed: Mar. 12, 2012

(30) Foreign Application Priority Data
Mar. 16, 2011 (KR) 10-2011-0023520

(51) Int. Cl. H01B 9/02

(52) U.S. Cl. 174/113 R

(57) ABSTRACT

Disclosed is a high frequency power cable including a central conductor centered in the cable having a plurality of metal strands twisted together in a cylindrical configuration, a conducting layer surrounding the periphery of the central conductor having a plurality of metal strands twisted together in a multilayered configuration, and an insulating layer surrounding the peripheries of the central conductor and the conducting layer.

### CROSS-REFERENCE TO RELATED APPLICATION

This application claims priority from Korean Patent Application No. 10-2011-0023520, filed on Mar. 16, 2011, the entire disclosure of which is incorporated herein by reference for all purposes.

### BACKGROUND

1. Field

The present invention relates to a power cable, and more particularly, to a high frequency power cable for high frequency power transmission.

2. Description of Related Art

Recently, to decrease the greenhouse gas emissions, there is an increasing tendency to use an electrical energy that can minimize the use of internal combustion engines and replace fossil fuels.

For example, an aircraft ground power system supplies electric power to an aircraft parked on the runway of an airport, so that the aircraft is not powered with fuel stored therein but by using the ground power system while on the ground. Electric cars, subways, electric propulsion ships, and the like use also using electrical energy as fuel are gaining popularity. The frequency of an electrical energy used in these fields is a high frequency of 400 Hz or more, rather than the usual frequencies of 50/60 Hz, which greatly increases the influence of skin and proximity effects and exerts a bad influence on the impedance of a conductor at a high frequency.

Here, the skin effect is the tendency of an electric current to distribute itself within a conductor with the current density being largest near the surface of the conductor, decreasing at greater depths. Also, if two conductors carrying the same current lie parallel to one another, the current is concentrated in areas furthest away from the conductors by an electric force between the conductors. The low density of the main current between the adjacent conductors and high density of the eddy current is termed the proximity effect. As frequency increases, the skin and proximity effects become stronger.

This non-uniform current density reduces the efficiency of a conductor. In other words, the electrical impedance indicating the efficiency of a conductor increases with frequency.

To minimize the problems caused by the non-uniform current density, there have been suggestions, for example, Japanese Patent Publication No. 2006-313745 (hereinafter referred to as conventional art 1) and European Patent No. 1916674 (hereinafter referred to as conventional art 2).

The conventional art 1 discloses a conductor structure including a central conductor of aluminum and a copper layer surrounding the central conductor. Since the central conductor has a smaller current density than the copper layer due to the skin effect, the conventional art 1 suggests aluminum having low conductivity for the central conductor to minimize the skin effect. However, an aluminum conductor has higher thermal loss when compared with a copper conductor having the same size. Thus, the conventional art 1 has limitations in fundamentally solving the skin effect problem.

The conventional art 2 discloses a power cable including a plurality of conductors, each conductor surrounded with an insulator. The reduced size of a respective conductor minimizes the skin effect and individual insulation minimizes the proximity effect. However, this structure is effective in reducing the skin effect but increases the use of the insulator and makes the minimization of the cable difficult. Also, there is an inconvenience of having to peel off a plurality of insulators from a plurality of conductors one by one when in use.

### DISCLOSURE

### Technical Problem

The present invention is designed to solve the conventional problems above, and therefore it is an object of the present invention to provide a high frequency power cable that can transmit power of high frequency of 400 Hz or more and effectively suppress the skin and proximity effects.

### Technical Solution

According to an aspect of the present invention, provided is a high frequency power cable including a central conductor centered in the cable having a plurality of metal strands twisted together in a cylindrical configuration, a conducting layer surrounding the periphery of the central conductor having a plurality of metal strands twisted together in a multilayered configuration, and an insulating layer surrounding the peripheries of the central conductor and the conducting layer.

Preferably, the conducting layer may have a multilayered structure including at least one layer.

Preferably, the central conductor and each layer of the conducting layer may be individually surrounded by the insulating layer.

Preferably, the insulating layer may be a semiconductor tape, an insulating tape, or a polymer resin.

Preferably, the high frequency power cable may further include a sheath layer provided at the outmost of the cable to protect the cable.

According to another aspect of the present invention, provided is a high frequency power cable including a central insulator centered in the cable having a circular cross section, a conducting layer surrounding the periphery of the central insulator having a plurality of metal strands twisted together in a multilayered configuration, and an insulating layer surrounding the periphery of the conducting layer.

Preferably, each layer of the conducting layer may be surrounded by the insulating layer.

### DESCRIPTION OF DRAWINGS

The accompanying drawings illustrate preferred embodiments of the present disclosure and, together with the foregoing disclosure, serve to provide further understanding of the technical spirit of the present disclosure. However, the present disclosure is not to be construed as being limited to the drawings.

FIG. 1 is a cross-sectional view illustrating a structure of a high frequency power cable according to an embodiment of the present invention.

FIG. 2 is a cross-sectional view illustrating a structure of a high frequency power cable according to another embodiment of the present invention.

### DETAILED DESCRIPTION

The present invention will now be described in detail with reference to the accompanying drawings. Prior to description, it should be understood that terms and words used in the specification and the appended claims should not be construed as having common and dictionary meanings, but should be interpreted as having meanings and concepts corresponding to technical ideas of the present invention in view of the principle that the inventor can properly define the concepts of the terms and words in order to describe his/her own invention as best as possible. Accordingly, the description proposed herein is just a preferable example for the purpose of illustrations only, not intended to limit the scope of the invention, so it will be apparent to those skilled in the art that various modifications and variation can be made in the present invention without departing from the spirit or scope of the invention.

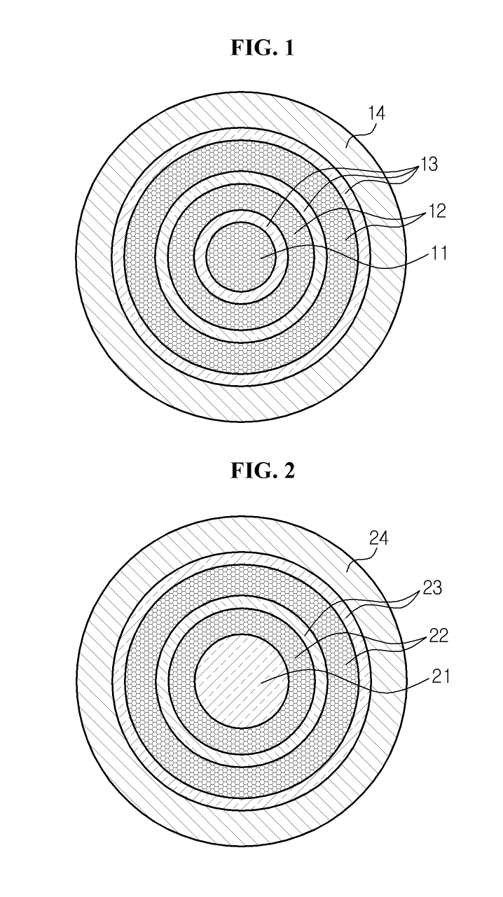

FIG. 1 is a cross-sectional view illustrating a structure of a high frequency power cable according to an embodiment of the present invention. FIG. 2 is a cross-sectional view illustrating a structure of a high frequency power cable according to another embodiment of the present invention.

As shown in FIG. 1, a high frequency power cable according to an embodiment of the present invention includes a central conductor 11, a conducting layer 12, an insulating layer 13, and a sheath layer 14 in order from the center thereof. The conducting layer 12 has a multilayered structure including at least one layer. The insulating layer 13 individually surrounds the central conductor 11 and each layer of the conducting layer 12.

The central conductor 11 is centered in the cable, and has a plurality of metal strands twisted together in a cylindrical configuration. The central conductor 11 is made from a conductive material, for example, copper, and serves as a medium through which power is transmitted within the cable.

The conducting layer 12 surrounds the periphery of the central conductor 11 and has a plurality of metal strands spirally twisted together in a multilayered configuration. The layers of the conducting layer 12 are arranged at a predetermined pitch relative to the central conductor 11. The conducting layer 12 is made from a conductive material, for example, copper, and along with the central conductor 11, serves as a medium of transmitting power within the cable.

The insulating layer 13 individually surrounds the peripheries of the central conductor 11 and the conducting layer 12 of the multilayered structure. Thereby the insulating layer 13 tightens the central conductor 11 and the conducting layer 12. Also, the insulating layer 13 electrically isolate the adjacent conductors, that is, the central conductor 11 and the conducting layer 12. The insulating layer 13 is made from a material having withstanding voltage characteristics and enough electrical characteristics to minimize the proximity effect between adjacent conductors. For example, the insulating layer 13 may include a semiconductive tape, an insulating tape, a polymer resin, and the like. In the case of a semiconductive tape or insulating tape, the insulating layer 13 is formed by taping the central conductor 11 or the conducting layer 12 using the tape. In the case of a polymer resin, the insulating layer 13 is formed by extrusion-molding the polymer resin around the periphery of the central conductor 11 or the conducting layer 12. However, the present invention is not limited to a specific material or forming method of the insulating layer 13.

The sheath layer 14 is provided at the outmost of the cable to protect the cable from external impacts or corrosion. The sheath layer 14 is formed by extrusion-molding a polymer resin to surround the internal components or elements and protect the entire cable.

Accordingly, the power cable according to an embodiment of the present invention includes the central conductor 11 centered therein and the conducting layer 12 of a multilayered structure surrounding the central conductor 11, thereby effectively suppressing the skin and proximity effects during transmission of high frequency power. In other words, the central conductor 11 and the conducting layer 12 that function as a power transmission medium of the power cable have a multilayered structure, in which each layer has a controlled size to equalize the impedance based on frequency, thereby minimizing the skin effect. Also, the insulating layer 13 is interposed between the central conductor 11 and the conducting layer 12 to electrically isolate the adjacent conductors, thereby minimizing the proximity effect. Thus, the power cable of the present invention can suppress the skin and proximity effects dependent on the frequency, voltage, and current. Also, the multilayered structure of the central conductor 11 and the conducting layer 12 improves the efficiency of the power transmission conductor and thus contributes to a compact and light-weight cable.

Referring to FIG. 2, a high frequency power cable according to another embodiment of the present invention includes a central insulator 21, a conducting layer 22, an insulating layer 23, and a sheath layer 24 in order from the center thereof. The conducting layer 22 has a multilayered structure including at least one layer. The insulating layer 23 surrounds each layer of the conducting layer 22.

The high frequency power cable of this embodiment has substantially the same structure as that of the previous embodiment except that the central insulator 21 is used instead of the central conductor 11. In particular, the high frequency power cable of this embodiment has an advantage of easily adjusting the size and standard of the multilayered conducting layer 22 to deliberately comply with the limited impedance conditions.

The central insulator 21 is centered in the cable and has a circular cross section. The central insulator 21 is formed by extrusion-compressing a polymer material of excellent insulation and tensile characteristics, or twisting high-strength polymer yarns or cotton threads at a predetermined pitch into a cylindrical form. The central insulator 21 improves the durability of the cable and secures a space for insulation.

The conducting layer 22 surrounds the periphery of the central insulator 21 and has a plurality of metal strands spirally twisted in a multilayered configuration. The layers of the conducting layer 22 are arranged at a predetermined pitch relative to the central insulator 21. The conducting layer 22 is made from a conductive material, for example, copper, and serves as a medium through which power is transmitted within the cable.

The insulating layer 23 surrounds the periphery of each layer of the conducting layer 22 and thereby tightens the conducting layer 22. Also, the insulating layer 23 electrically isolates the adjacent conductors, that is, the layers of the conducting layer 22. The insulating layer 23 is made from a material having withstanding voltage characteristics and enough electrical characteristics to minimize the proximity effect between adjacent conductors. For example, the insulating layer 23 may include a semiconductive tape, an insulating tape, a polymer resin, and the like. In the case of a semiconductive tape or insulating tape, the insulating layer 23 is formed by taping the conducting layer 22 using the tape. In the case of a polymer resin, the insulating layer 23 is formed by extrusion-molding the polymer resin around the periphery of the conducting layer 22. However, the present invention is not limited to a specific material or forming method of the insulating layer 23.

The sheath layer 24 is provided at the outmost of the cable to protect the cable from external impacts or corrosion. The sheath layer 24 is formed by extrusion-molding polymer resin to surround the internal components or elements and protect the entire cable.

The high frequency power cable of this embodiment has the same effects as that of the previous embodiment. In particular, the high frequency power cable of this embodiment has an advantage of easily adjusting the size and standard of the multilayered conducting layer 22 due to the absence of the central conductor 11 of the previous embodiment, so that the power cable can satisfy fastidious impedance limitations.

According to teachings above, the high frequency power cable of the present invention has an improved structure of the inner conductor, thereby suppressing the skin and proximity effect to the maximum during transmission of high frequency power. Also, the power cable has an advantage of cost and weight reduction by decreasing an amount of the inner conductor used. Furthermore, the power cable has the parallel arrangement of the inner conductor to lower the total impedance of the cable, thereby preventing the voltage drop. Also, since it is easy to peel off the insulator when in use, the power cable may be easy to use and convenient from a user's perspective.

Although the present invention has been described hereinabove, it should be understood that the detailed description and specific examples, while indicating preferred embodiments of the invention, are given by way of illustration only, since various changes and modifications within the spirit and scope of the invention will become apparent to those skilled in the art from this detailed description.

What is claimed is:

1. A high frequency power cable comprising:
a central conductor centered in the cable having a plurality of metal strands twisted together in a cylindrical configuration;
a conducting layer surrounding the periphery of the central conductor having a plurality of metal strands twisted together in a multilayered configuration; and
an insulating layer surrounding the peripheries of the central conductor and the conducting layer.

2. The high frequency power cable according to claim 1,
wherein the conducting layer has a multilayered structure including at least one layer.

3. The high frequency power cable according to claim 2,
wherein the central conductor and each layer of the conducting layer is individually surrounded by the insulating layer.

4. The high frequency power cable according to claim 3,
wherein the insulating layer is a semiconductor tape, an insulating tape, or a polymer resin.

5. The high frequency power cable according to claim 1, further comprising:
a sheath layer provided at the outmost of the cable to protect the cable.

6. A high frequency power cable comprising:
a central insulator centered in the cable having a circular cross section;
a conducting layer surrounding the periphery of the central insulator having a plurality of metal strands twisted together in a multilayered configuration; and
an insulating layer surrounding the periphery of the conducting layer.

7. The high frequency power cable according to claim 6,
wherein the conducting layer has a multilayered structure including at least one layer.

8. The high frequency power cable according to claim 7,
wherein each layer of the conducting layer is surrounded by the insulating layer.

9. The high frequency power cable according to claim 8,
wherein the insulating layer is a semiconductor tape, an insulating tape, or a polymer resin.

10. The high frequency power cable according to claim 6, further comprising:
a sheath layer provided at the outmost of the cable to protect the cable.
